(19) United States
(12) Patent Application Publication
(10) Pub. No.: US 2011/0232805 A1
(43) Pub. Date: Sep. 29, 2011

(54) Carpenter's portable, compact, and flat construction work station

(76) Inventor: Richard T. DeSpain, Midvale, VT (US)

(21) Appl. No.: 12/748,581

(22) Filed: Mar. 29, 2010

(51) Int. Cl. B25H 1/04; B25H 1/12

(52) U.S. Cl. 144/285; 269/17; 280/639

(57) ABSTRACT

An integrated work surface and tool storage system. There is shown a plurality of panels, forming a box-like shape, having a support structure, supporting at least the edges of the box-like shape formed by the plurality of panels; and a plurality of hinges coupled to the support structure, that enable the plurality of panels to have a storable position state that fold the panels into a box-like shape, and a deployable panel state where the panels form a flat work surface located above the support structure. There is shown a motorized system, coupled to the support structure, to be activated to cause the tool box to move. This design would include at least two wheels located on either side of the tool box, wherein at least one wheel is coupled to the motorized system. In addition, there is shown a first and second flexible continuous track coupled around each of the two wheels located on either side of the tool box. A radio frequency remote control device is taught that is electrically coupled, via radio frequency, to the motorized system, designed to enable a user to remotely control the movement of the tool box.

### CROSS-REFERENCE TO RELATED APPLICATIONS

This application claims the benefit of U.S. Provisional Patent Application No. 61/211,028 filed Mar. 26, 2009, and entitled, PORTABLE FINISH CARPENTER WORK STATION, and invented by Richard T. DeSpain, Midvale, Utah, wherein the entire subject of which is hereby incorporated herein by reference.

### BACKGROUND OF THE INVENTION

1. Field of the Invention

The present invention relates to a workbox storage system. In particular, there is a work box that enhances the work environment for construction workers, and in particular, finish carpentry work, and other key unique features that will become apparent after a complete review of the specification and drawings regarding the present invention.

2. Description of the Related Art

The modern construction professionals are required to move all their equipment for each and every new construction sites. Most construction sites do not provide for any safe and convenient carpentry work stations or tool storage areas. Many construction sites also have disorganized work surfaces filled with mud, rocks, discarded wood, bushes, weeds, trees, brush, uneven ground, soft grass, tire ruts, and much more. Additionally, the numbers of tools that must be relocated to each site are legion. There are small hand tools, like hammers, screwdrivers, files, nails, screws, levels, chalk lines, etc. There are large electric and pneumatic tools like band saws, routers, miter saws, circular saws, table saws, nail guns, drills, grinders, sanders etc. Then there is the problem of providing a flat work surface to use during the operation of many of the tools and equipment. Add to that, there is a need for both electric and pneumatic power supplies and plug-ins. Thus, there have been many inventions for tool carts enabling contractors to move their tools around the job site and to have a flat work bench. Improvements have been made in the field, and examples are described below, wherein the supported teachings of each reference are herein incorporated by reference from each of the following cited patents, for example:

U.S. Pat. No. 2,672,349, issued in 1952, teaches the use of a mobile workbench having wheels for mobility.

U.S. Pat. No. 4,230,329, issued in 1980, teaches the use of a mobile cart having a remotely controlled retractable support wheel assembly and a support frame adapted to support and transport doors and the like carried along with a carpenter's other wood working tools.

U.S. Pat. No. 4,878,554, issued in 1989, teaches of a battery motorized mail cart to be used by mailpersons in delivering mail from the U.S. Postal Services.

U.S. Pat. No. 5,224,531, issued in 1993, teaches of a portable shop for storing tools in an organized fashion and that also converts to a combination saw table, router table and workbench.

U.S. Pat. No. 5,764,697, issued in 1998, teaches of a transmitter for a radio control device used to remote control a movable device.

U.S. Pat. No. 5,885,159, issued in 1999, teaches of a system for and method of remotely controlling the operation of toys using radio frequency transmitters and receivers.

U.S. Pat. No. 6,005,508, issued in 1999, teaches of a remote transmitter receiver controller system used to remotely control devices using transmitters and receivers on a transmission frequency.

U.S. Pat. No. 6,170,839, issued in 2001, teaches of a tool cart with a tool chest, a hand truck, a tool box, extension cord reel, and at least one side storage bag.

U.S. Pat. No. 6,659,565, issued in 2003, teaches of a motorized hand truck for driving and steering a wheeled accessory and is removably connected to the hand truck to be powered and directed in response to operation of the hand truck.

U.S. Pat. No. 6,848,968, issued in 2005, teaches of a communication system for radio controlled toy vehicles.

U.S. Pat. No. 7,306,245, issued in 2007, teaches of a multipurpose work site utility charier that configures into a dolly and hard truck in its retraced mode and a work bench in its elevated mode.

U.S. Pat. No. 7,374,184, issued in 2008, teaches of a portable table for table saws having a pair of removable horizontally extending handles.

The inventions described in the patents heretofore, suffer from a number of disadvantages. For example, all patents teach of using wheels that will easily sink into soft dirt or mud that is very typical in and around construction sites. The sinking wheels will imbed in the dirt so far as to cause the bottom of the tool box to get stuck there and prevent easy movement of the tool box. Additionally, the simple weight of the tool filled tool box alone will cause the wheels to sink into grass lawns, which is not desired by home owners with nice lawns. Moreover, wheels do not easily move over rocks, lumber, piping, cords, cracks in cement and anything else creating an uneven surface.

Additionally, the cited art teaches the use of wheels because construction workers have typically been strong robust workers, and if they were not such, they were eliminated from such construction profession. However, new laws have now prevented discrimination based on physical abilities and now allow for woman and disabled people to now have such construction professions. None of the cited art either singularly or in combination teaches of easily movable tool boxes and non-sinkable wheel designs.

Additionally, the cited prior art does not teach of practical, integrated or elegant designs for providing adequate work surfaces and compact tool storage. These new designs need to include allowing proper storage for the numbers of tools that must be relocated to each site. These new designs also need to include storage of small hand tools, like hammers, screwdrivers, files, nails, screws, levels, chalk lines, etc. Additionally, these new designs must include storage for large electric and pneumatic tools like band saws, circular saws, table saws, nail guns, drills, grinders, sanders etc. The new designs must additionally include storage for providing a flat work surface to use during the operation of many of the tools and equipment. Add to that, the new designs must include storage for both electric and pneumatic power supplies and plug-ins.

What is needed is a movable tool box that solves one or more of the problems described herein and/or one or more other problems that may come to the attention of one skilled in the art upon becoming familiar with this specification, drawings and appended claims.

### SUMMARY OF THE INVENTION

The present invention has been developed in response to the present state of the art, and in particular, in response to the problems and needs in the art that have not yet been fully solved by currently available motorized tool box and flexibly designed work bench. Accordingly, the present invention has been developed to provide solutions to the problems presented and others made evident by understanding the present invention as described in the specification, drawings, and appended claims.

There is described, in one embodiment, an integrated work surface and tool storage system. There is a plurality of panels, forming a box-like shape, having a support structure, supporting at least the edges of the box-like shape formed by the plurality of panels; and a plurality of hinges coupled to the support structure, that enable the plurality of panels to have a storable position state that fold the panels into a box-like shape, and a deployable panel state where the panels form a flat work surface located above the support structure.

In another embodiment, there is additionally described and integrated work surface and tool storage system that includes a motorized system, coupled to the support structure, to be activated to cause the tool box to move. This design would include at least two wheels located on either side of the tool box, wherein at least one wheel is coupled to the motorized system.

In an additional embodiment, there could be a first and second flexible continuous track coupled around each of the two wheels located on either side of the tool box.

Yet a further embodiment would include a radio frequency remote control device, electrically coupled, via radio frequency, to the motorized system, designed to enable a user to remotely control the movement of the tool box.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of a portable finish carpenter work station depicted in a fully deployed state, according to a preferred embodiment of the present invention;

FIG. 2 is a perspective view of portable finish carpenter work station depicted in a fully expanded state, according to a preferred embodiment of the present invention;

FIG. 3 illustrates a perspective view of an embodiment of the invention with a folded down side;

FIG. 4 illustrates a perspective view of a top view of the work surface;

FIG. 5 illustrates a perspective view of a portion of the work surface;

FIG. 6 illustrates a perspective view of a partially expanded top surface;

FIG. 7 illustrates a side view of an embodiment;

FIGS. 8a and b illustrate a side sectional view of embedded claims;

FIG. 9 illustrates perspective view of a partially collapsed embodiment;

FIG. 10 illustrates an end view of a closed end of an embodiment;

FIG. 11 illustrates an end view of a partially opened embodiment;

FIG. 12 illustrates a top view with partially opened end portion of one embodiment;

FIG. 13 illustrates a side view of a closed embodiment;

FIG. 14 illustrates an end view of an embodiment;

FIG. 15 illustrates a side view of supported panel of an embodiment;

FIG. 16 illustrates a motorized tractor embodiment; and

FIG. 17 illustrates a side view with interior positioning of heavy electrical tools mounted in one embodiment.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification, to an “embodiment,” an “example,” “feature” or similar language, may have several meanings. First, the meanings may indicate that a particular feature, structure, characteristic, or combinations thereof described in connection with the embodiment is included in at least one embodiment of the present invention. Second, the meanings may also indicate that all references are being made to the same embodiment, to different embodiments, or to one or more of the figures. Additionally, the meanings that indicate two or more features, elements, parts, pieces, etc. do not necessarily mean that the features are related, dissimilar, the same, etc. Third, each use of the above wording can be considered independent of any other statement of the above wording despite any use of similar or identical language characterizing each embodiment or example. Where one embodiment is identified as “another embodiment,” the identified embodiment is independent of any other embodiments characterized by the language “another embodiment.” Further, the features, functions, and the like described herein are considered to be able to be combined, in whole or in part, one with another, as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of”.

The terms “a” and “an” herein do not denote a limitation of quantity, but rather denote the presence of at least one of the referenced items.

The present invention describes a portable construction work station 10 (herein described as the “apparatus” and such). The work station provides a means for a workbox storage system comprising features which enhance the work of construction, and in particular finish carpentry work. The apparatus 10 provides for complete storage, transportation, and utilization of various hand tools, power tools, and similar common carpentry tools. A plurality of hinged panels is provided to fold up from the sides and provide a large, flat work space for construction work, an in particular, for carpentry finishing work and the like. There is also provided a large inner storage space that enables various tools and equipment to be stored therein. Additionally, there is provided motorized tracks that can easily maneuver in a cluttered and soft ground without getting stuck or causing damage to nice work ground conditions, like soft lawns.

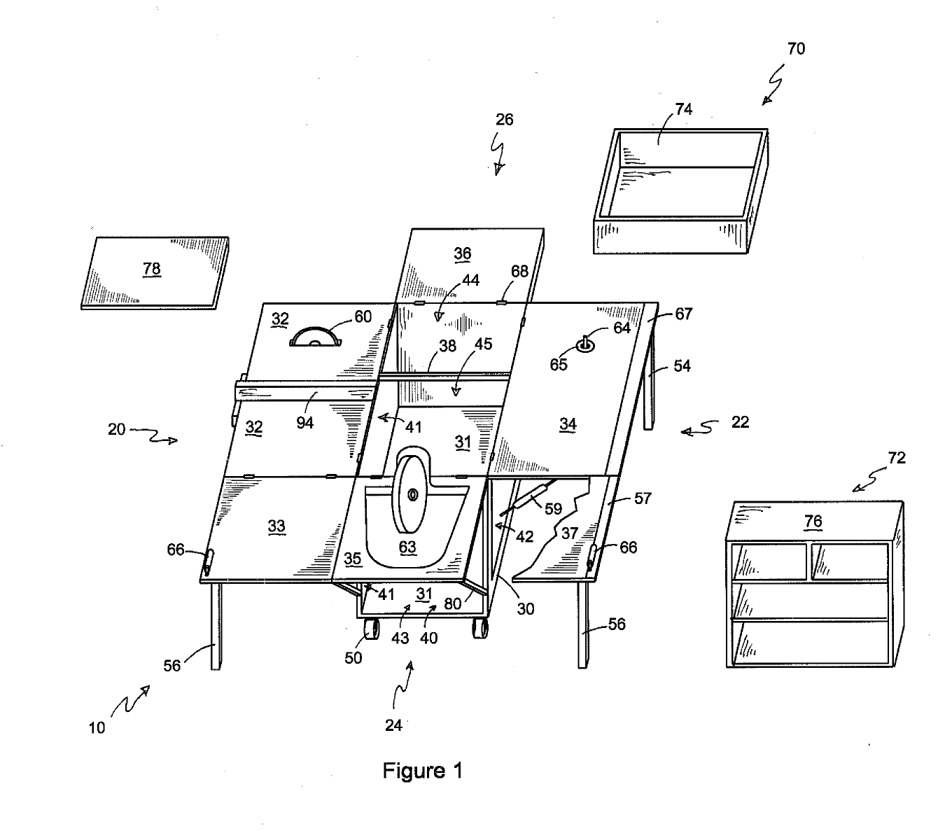

Referring now to at least FIG. 1, in this embodiment, there is a perspective view of the apparatus 10 depicted in a fully deployed state, according to one preferred embodiment of the present invention. The apparatus 10 may comprise in an embodiment a generally tool box frame body 30, which further comprises a bottom panel 31 and plurality of outer side panels; including a first panel 32, a second panel 33, a third panel 34, a fourth panel 35, and a fifth panel 36. Each panel 32-36 may be made of a durable, rigid material with a high strength to weight ratio, such as thermoplastic, aluminum, wood, or the like. The panels 32-36 may be designed to fold up from a side of the frame body 30 via a hinge 68 or the like, thereby forming a large, flat work surface as illustrated.

The apparatus 10 may further comprise a large interior space 40 defined by the frame body 30, which provides a storage area for the tools, equipment, sliding storage bins and the like. The interior space 40 may be envisioned to be accessed therethrough a first opening 41 located on a first side 20, a second opening 42 located on a second side 22, and a third opening 43 located on a third side 24. The first panel 32 may be hingedly 68 attached to an upper end of the first side 20 of the frame box 30, and allows access thereto and a cover for the interior space of the first opening 41.

The second panel 33 may allow access thereto and a cover for the interior space third opening 43 located on a third side 24. The second panel 33 is hingedly 68 attached to the third side 24 at an end of the first panel 32.

The third panel 34 may be hingedly 68 attached to an upper end of the second side 22 of the frame box 30, and allows access thereto and a cover for the interior space by the second opening 42. The first panel 32 may be supported on the fourth side 26 by a first leg 54 (not shown in this figure).

The first leg 54 is envisioned to retract, fold, and fasten to an underneath surface of the first panel 32 in a folded state and unfasten, unfold, and extend to a ground surface when in a deployed state. The second panel 33 may be supported on the third side 24 by a second leg 56. The second leg 56 may retract, fold, and fasten to the underneath surface of the first panel 32 when in a folded state and unfasten, unfold, and extend out from the first panel 32, in order to support the second panel 33, and contact the ground surface when in the deployed state.

The legs 54, 56 may be fasten to the underneath surface of the first panel 32 via a magnet, a latch, a pin, or the like and may lock in an extended or a retracted position via a spring pin, a button pin, a quick release pin, or the like.

The third panel 34 is envisioned to be supported on the fourth side 28 by the first leg 54 and on the third side 24 by the second leg 56. The first leg 54 may retract, fold, and fasten thereto an underneath surface of the third panel 34 in the folded state and unfasten, unfold, and extend thereto a ground surface when in the deployed state. The second leg 56 may retract, fold, and fasten thereto the underneath surface of the third panel 34 when in the folded state and unfasten, unfold, and extend out therefrom the third panel 34 and contact the ground surface when in the deployed state. An extending member 57 may provide an extension means thereto the second leg 56.

A hydraulic cylinder 59 may be attached between an outside top edge of the bottom panel 31 and the first panel 32 and between an opposing outside top edge of the bottom panel 31 and the third panel 34. Thus, this arrangement provides a way of assisting in the unfolding and deployment of the first and second panels 32 and 34. The hydraulic cylinder 59 is envisioned to comprise features similar to other common hydraulic lifting and support cylinders, such as a cylinder barrel, a piston rod, and end devises and attach thereto the panels 31, 32, 34 via standard mechanical hardware.

The fourth panel 35 may hingedly attach to an upper end of the third side 24 of the frame box 30 and allows access to and a cover for an interior space by the fifth opening 45.

The fifth panel 36 may hingedly attach to an upper end of the fourth side 26 of the frame box 30 and allows access to and a cover for an interior space by the fourth opening 44.

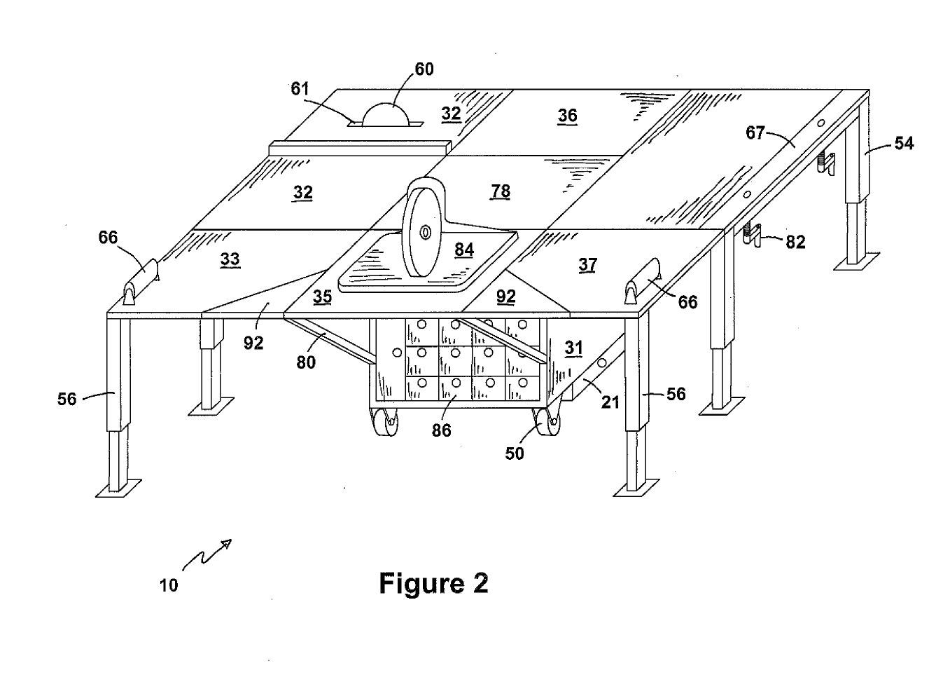

The fourth panel 35 and fifth panel 36 rest on a cross member 38 when in the folded state. When in the deployed state, the fourth panel 35 is supported by an extended first handle 52 (see FIG. 2) and the fifth panel 36 is supported by an extended second handle 53 (see FIG. 2).

The apparatus 10 enables large carpentry power tools to be mounted thereon, providing a way of storing, transporting, and setting up the tools at a workspace in a time and space saving manner. For example, in one embodiment there is deployed a table saw 60 mounted to an underside surface of panel 32, having a saw blade extend through a blade aperture 61.

In another embodiment, there is illustrated a miter saw 63 mounted to a top surface of the fourth panel 35.

Further, in another embodiment there is a router 64 that may be mounted to an underside surface of the third panel 34, which has the router bit extending through a bit aperture 65.

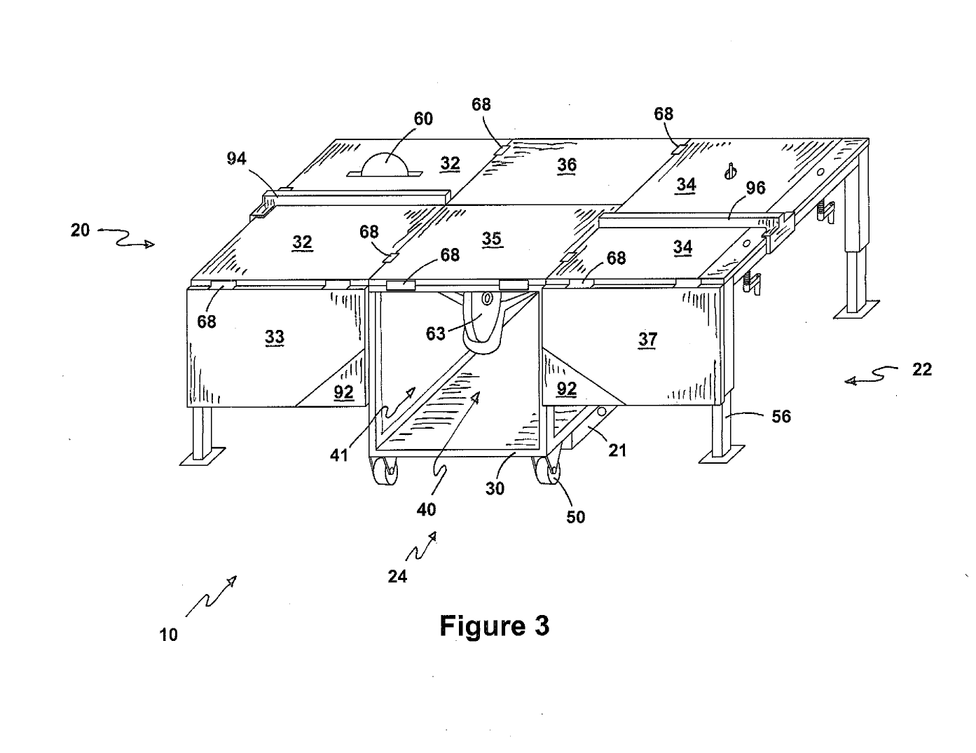

In FIG. 3, there is illustrated, in one embodiment, the apparatus having further key features. There may be at least one safety fence 94 and/or 96, which provides a cutting guide that attaches and tightens to the top of the first panel 32 and/or third panel 34 respectively. The fences 94 and 96 may be running from a front 24 to a back 26 of the apparatus 10. The fences are used to guide sheet plywood, or other wood, to circular saw 60. It is noted that miter saw 63, for example, still located in the apparatus cavity 40. Also, opening 41 is also exposed to see under panel 32. Additionally, it is noted that panels 33 and 37 are not rotated upward 90 deg. and are hingedly attached to their respective panels 32 and 34. Further, insert panel 78 is not inserted into the location of panel 35, since panel 35 is not in its open and mounted position.

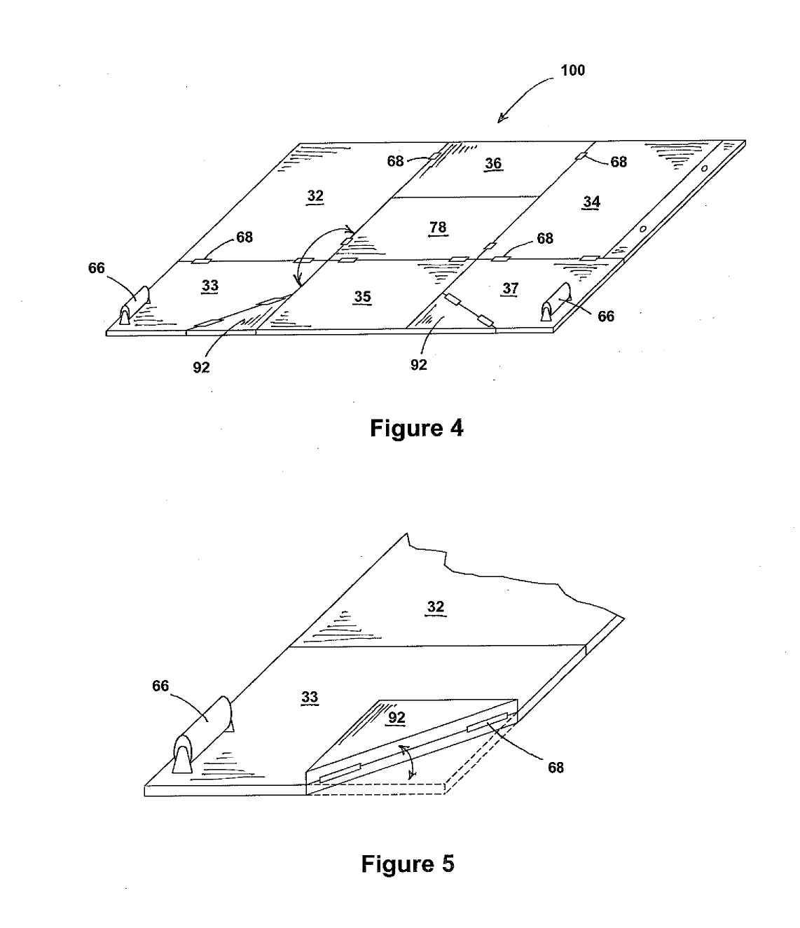

Reviewing FIG. 4, there is illustrated a fully extended flat work surface 100. It is noted that panel 78 is inserted in the location vacated by panel 35. Additionally, it is noted that none of the electric working tools are illustrated so that the work surface can be clearly viewed.

FIG. 5 illustrates a perspective of a special feature on panel 33. In particular, corner panel 92 is illustrated in a folded up position. Panel 92 raises the work surface to be closer to the height of support roller 66 so that at least the wood being worked by the miter saw 63 may has additional support.

It is noted that the apparatus 10, in yet another embodiment, further provides for at least two saw support roller members 66, which may provide a similar function as that of a standard saw horse and provide a height adjustable support to longer work pieces or boards, which are intended to be cut. One or more of the saw support members 66 may be removably attached to the top surface of the appropriate panel superajacent to the appropriate leg.

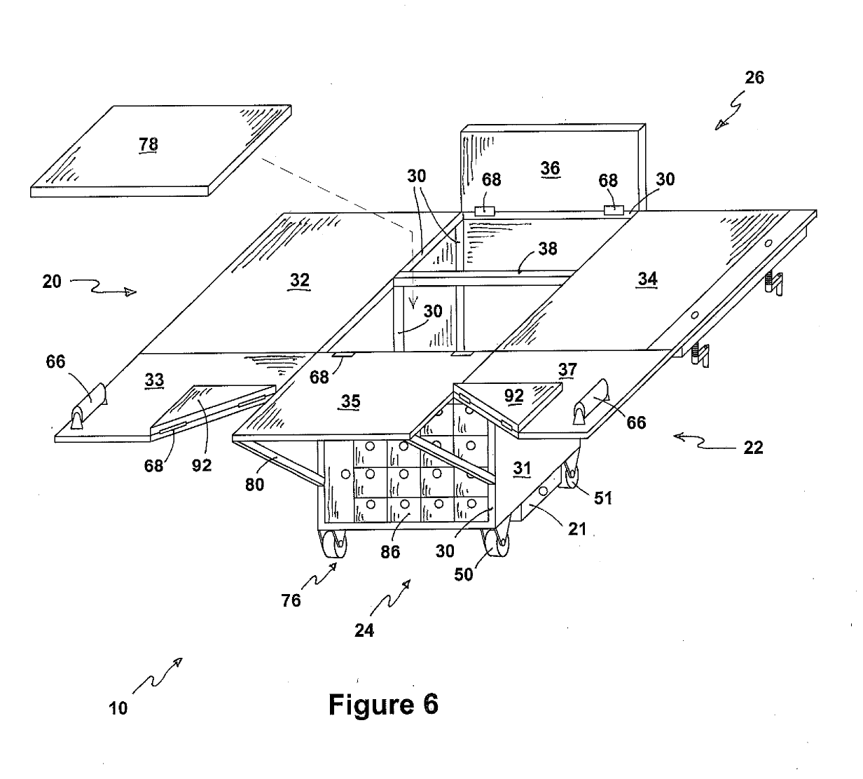

Referring to FIG. 6, there is a perspective view of the apparatus in a partially folded out state. It is noted that no fold out legs or mounted electric tools are illustrated to clearly show the folding out of the surfaces. It is particularly noted that panel 78 is to be inserted into the opening created after panel 35 has been pivotally opened 180 degrees. Also, support brackets 80 are put into supporting positions to hold up the weight of the miter saw (not illustrated). Further, panel 36 is illustrated in a partially rotated open position, but that the panel may rotate another 180 deg. so that it will not hinder a user from gaining access to the cavity 40.

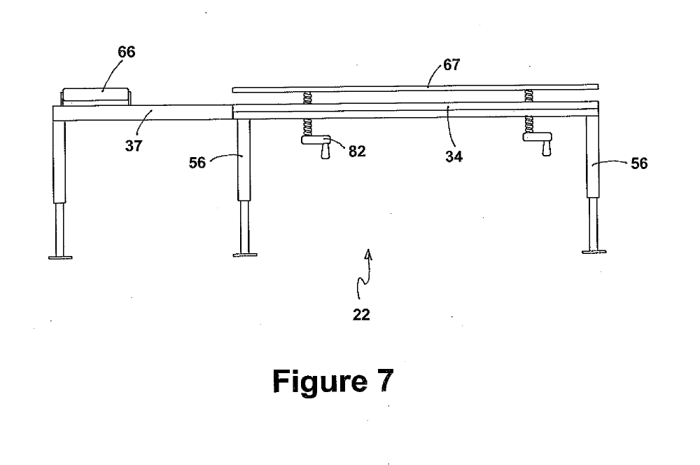

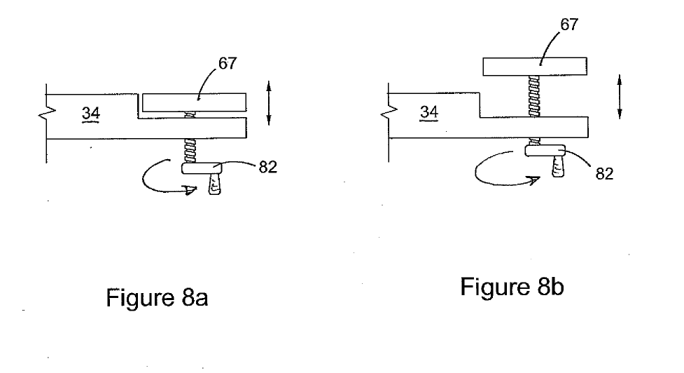

Regarding FIGS. 7, 8a and 8b, there is illustrated a side view of the apparatus 10, in one embodiment, which notably includes a clamp 67, located on an outer edge of the third panel 34. The clamp 67 illustrates a common screwable handle 82 that adjusts the height and may be used to lock over and clamp a piece of working material. The clamp 67 further rests in a recessed edge of the third panel 37 to be flush with the surface in a closed position.

It is further noted, all of the panels 32, 33, 34, 35, 36 may be hingedly attached via a plurality of hinges 68 to the frame to allow for opening and closing of the panels in the illustrated design. In one embodiment, a first insert panel 78 may be removably located in the interior space of the fourth opening 44 to act as the lid for the vacancy left by panel 35 when in an open position.

In at least FIGS. 1 and 6, in one embodiment, there is illustrated a potential plurality of multi-sized compartments 76 and/or drawers 86, which provide a portable, removable storage means for commonly used hardware, fasteners, and the like. These drawers or compartments may be located in a variety of places in the apparatus 10. For example, they may be located at end 24 or side 22, and my be fixed or removably placed therein.

The edges of the panels 32, 33, 34, 35, 36 may be rounded or comprise a flexible member between the seams of each panel. This design allows for a smooth surface which may minimalize the chances of scratching the material.

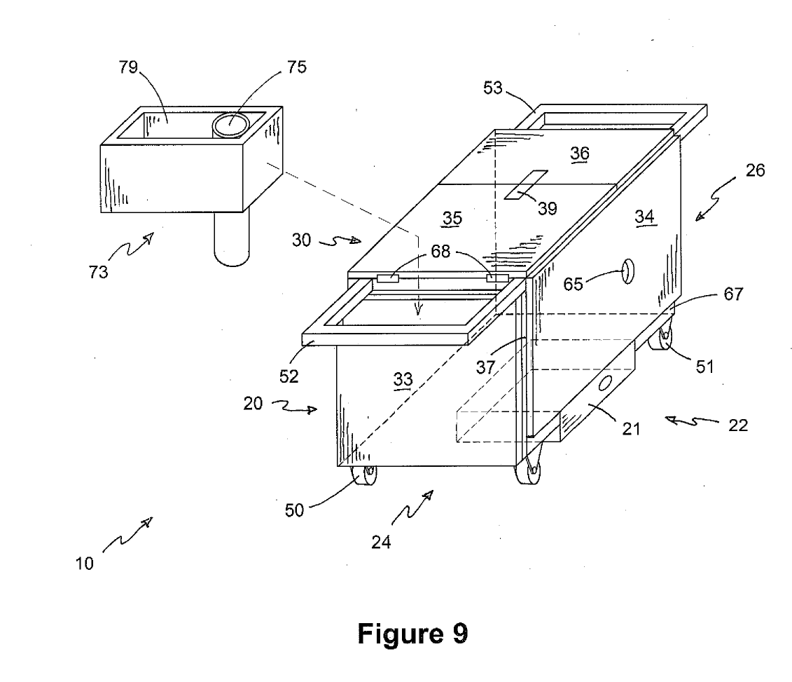

Referring now to at least FIG. 9, there is a perspective view of one embodiment of the apparatus 10 depicted, according to one embodiment. In the fully collapsed state, the apparatus 10 provides a way for storing, securing, and transporting the entirety of the working area and interior tools. The apparatus 10 may use two (2) first wheels 50 located on the third side 24 and two (2) second wheels 51 located thereon the fourth side 26. The second wheels 51 are envisioned to rotate along a vertical and horizontal axis, while the first wheels 50 are envisioned to maintain a rigid alignment along a vertical axis, thereby providing for easy steering of the apparatus 10. A first handle 52 and the second handle 53 may exist to extend out as illustrated and retract into the frame body 30 and lock into position via a spring pin, a button pin, a quick release pin, or the like. The handles 52, 53 may provide a gripping and steering ability for maneuvering the apparatus 10. The panels 32, 33, 34, 35, 36 are envisioned to secure and lock in the collapsed position, thereby providing physical security to the valuables, which are stored inside, via a locking mechanism 39.

The apparatus 10 may further have a third insert 73 which is envisioned to be removably inserted in the first or second handle 52, 53. The third insert 73 comprises a cylindrical storage area 75 which provides a means for 25 storing long tools such as levels or the like and a miscellaneous storage area 79 which provides a means for storing miscellaneous items.

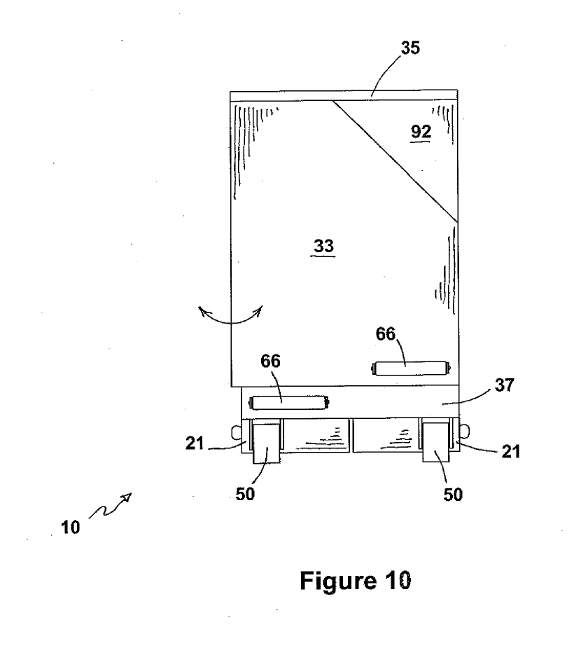

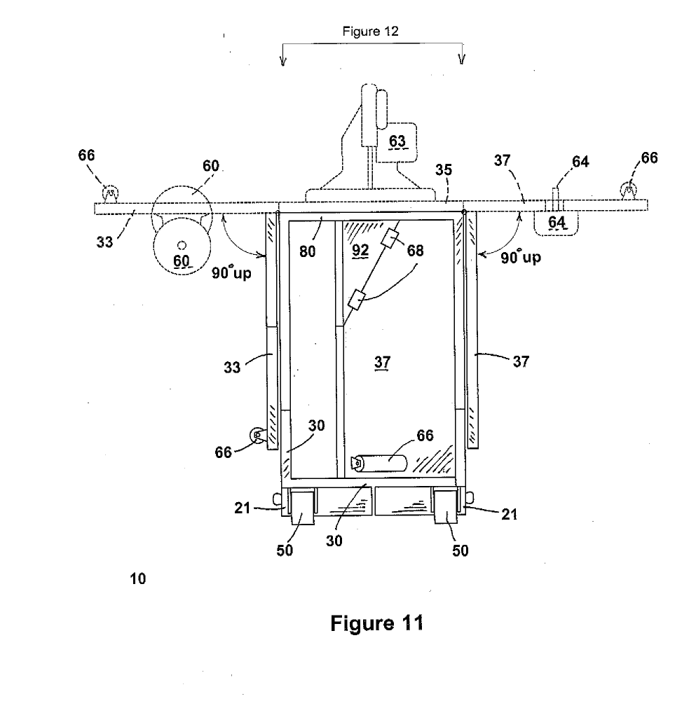

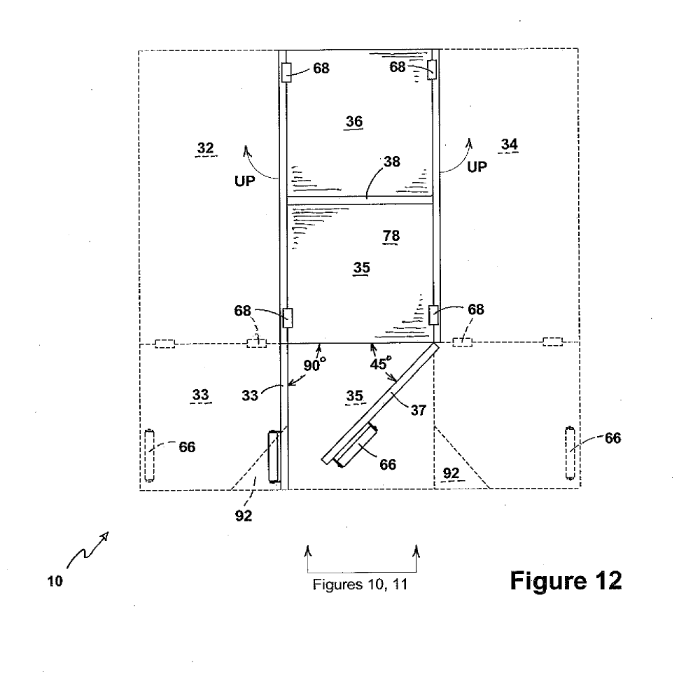

Referring to at least FIGS. 10, 11 and 12, there is illustrated the apparatus in the various folding states and the key features provided therewith. Specifically, in FIG. 10 there is illustrated the staggered positioning of rolling wood supports 66 when the panels 33 and 37 are folded up for storage. Wherein, panel 33 is shorter to not cover roller support mounted on panel 37. In FIGS. 11 and 12, there is shown the step where panel 33 if opened 90 deg. outward, and panel 37 is opened 45 deg. outward. Additionally, both figs. show in phantom line of the panels when they are fully lifted up by 90 deg. to form the working surfaces. FIG. 12 also shows that panel 35 is in its folded stage, but also shows in phantom that panel 78 will be placed therein when panel 35 is in its deployed position, which is also shown in its phantom panel 35 position.

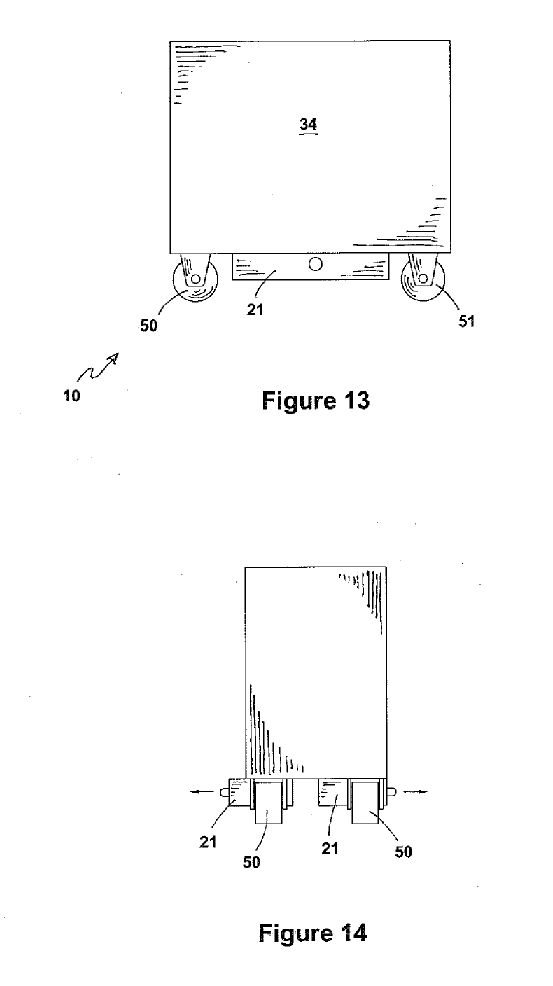

FIGS. 13 and 14, in one embodiment, illustrate the folded apparatus with the slidable under side drawers 21 mounted thereon.

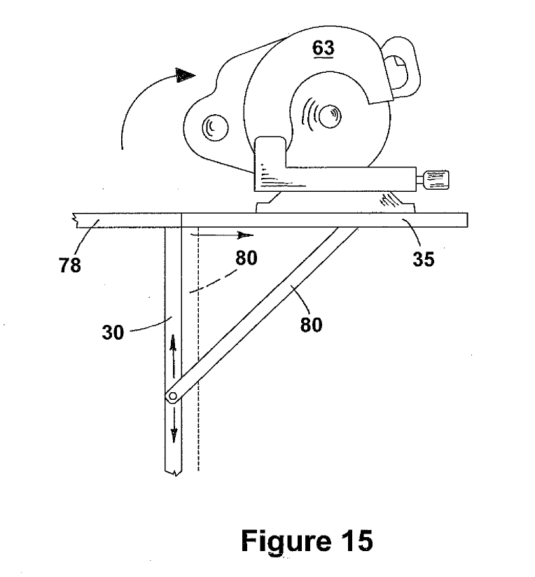

FIG. 15, illustrates one embodiment, where panel 35 is fully employed with fixedly attached miter saw 63 positioned thereon. Uniquely, support frame 80 is moved from its phantom lined position, next to frame 30, and slidably moved upward at the bottom, and rotatably moved on the top end into a supporting position illustrated, to hold up the weight put onto panel 35. Both the bottom and top end of support 80 will be locked into position in any known fashion. Additionally, any known slidable locking mechanism will work for the support frame 80. It is noted that panel 78 is shown to have been inserted into the location that panel 35 has been rotated out of Further, it is also illustrated that the electrical device, shown in the form of a miter saw 63, is illustrated that when panel 35 is rotated into its deployed position, that the saw is in a top side position, and ready to be used.

Wherein, it is generally noted, other fixedly mounted electrical equipment, like routers and such, must be located under the table surface for meaningful usage. As such, all bottom mounted devices are positioned on the side panels 32, 34, since those rotate upward 90 degrees to be in the working plane. Whereas, any top fixedly mounted working tools, like the miter saw, will be mounted on panel 35, since it is rotated 180 degrees to be in the working plane. Thus, in the folded assembly, all of the electrical mounted tools can be folded into the inside cavity 40 of the assembly 10 during storage and transportation.

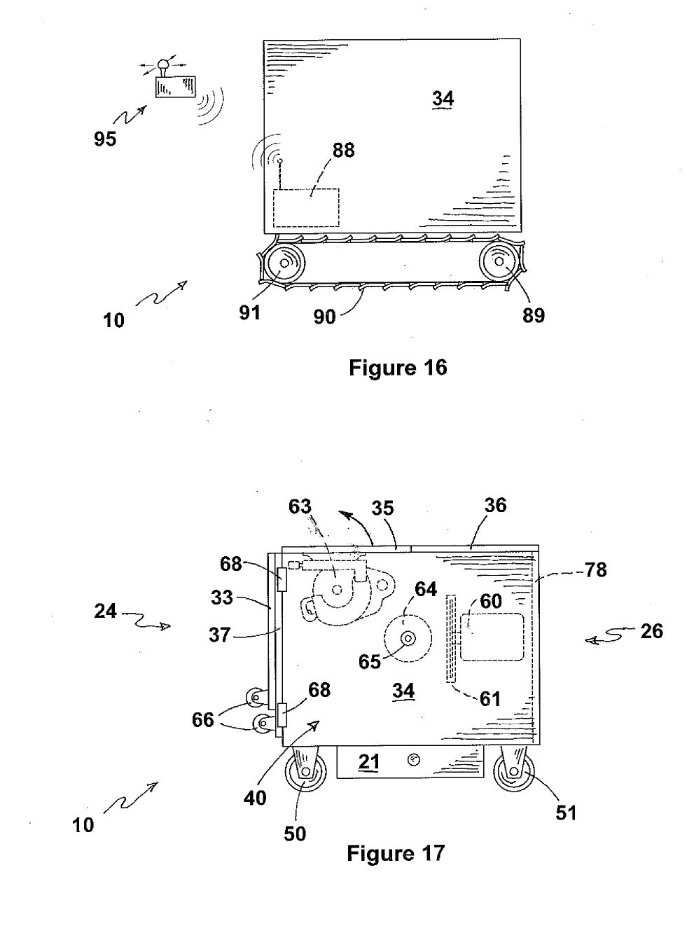

Referring to FIG. 16, there is illustrated a side view of the assembly 10. Specifically, there is shown the use of a motorized tractor system, which uses a remote control hand held radio frequency device 88, and a motor control system 88 that drives the wheels 89 and 91 that move the treds 90. The cited art teaches of several known ways to control a remote control vehicle, and are herein incorporated by reference in teaching how the motorized control system 88 and remote control device 95 would be configured and operate to achieve the desired moving of the toll system 10. Having treds, instead of wheels, allows for easy movement of the often extremely heavy storage system over uneven ground and may causes less damage to soft ground or manicured lawns.

Regarding FIG. 17, there is illustrated a side view with the phantom lines of the large electrical tools positioning during storage. It is understood that the apparatus 10 may have various types of tools, like jig saws, routers, and band saws, mounted to the panels 32, 34, 35, 36 in various configurations. Specifically, the mounted tools are specifically situated so that the tools do not interfere with one another while folded into the interior space 40 of the apparatus 10. This large electric tool positioning provides for the compactness of the apparatus 10 when in a folded state. In particular, tool 63, like a miter saw, is coupled to the top surface of panel 35 so that when the panel is rotated 180 deg. from its fully deployed state, it is located in the illustrated hanging down position and located at end 24. Additionally, tool 64, like a router, is coupled to the bottom surface of panel 34, and is located in a central position in cavity 40. Additionally, when panel 34 rotated upward 90 deg., the tool 64 is positioned on the bottom of the overall work surface, and has router bit sticking up and through the hole 65. Thus, being fully deployed and ready to use. Further, tool 60, like a circular saw, is coupled to the bottom surface of panel 32, in a position near end 26 at a right side of the apparatus 10. Thus, when panel 32 is rotated open 90 deg., the tool 60 is positioned on the bottom of the overall work surface of the apparatus 10 and the blade extends through blade hole 61. It is further noted that cover panel 78 is illustrated in a stored position at the wall near end 26.

It is further noted that when panel 34 is rotated upward, that panel 37 is connected thereto, and thus will also rotate upward, but will not be in a deployed state, but will half deployed, like that shown in FIG. 3. Same arrangement exists for panel 32 and 33. Thus, panels 33 and 37 work like two sheets of paper stacked on top of each other, where one can be slid out from under the other as the adjoining panels are moved accordingly.

It is additionally noted that the positioning of the erected work surface 100 is located above and supported by the support structure 30. The support structure may be designed, in one embodiment, in a rectangular shape (not fully visible) and positioned along the location of the edges of the tool box. One skilled in the art of making tool boxes of a larger structure than a hand held box would know of the design of the needed support structure, and the importance of the supporting nature thereof. The support structure may be made of metal square tubing. It may also be a single box shape (located along the edges of the box) or have intermediate supporting pieces like that at least illustrated in FIG. 6, that shows cross bar 38 and other support structure pieces 30.

2. Operation of the Preferred Embodiment

The preferred embodiment of the present invention can be utilized by the average user in a simple and effortless manner, and with little or no training. The method of utilizing the apparatus 10 may be achieved by performing the following steps: transporting said apparatus 10 to a desired work area and disengaging the locking mechanism 39, thereby unlocking the panels 32, 33, 34, 35, 36. Then, the user would place the apparatus in a deployed state by rising the panels 32, 33, 34 by 90 degrees, and panel 35 by 180 deg. to create a desired work surface. Thus, the user now has access to the desired openings 41, 42, 43, 44, 45, and to utilize the attached tools 60, 63, and 64. Next, the user would unfasten, unfolding, and extend the legs 54, 56, that are mounted to the respective panels in each corner of the overall work surface 100. The legs are mounted like most any known method known for foldable leg mounting to other tables and such. The legs are deployed to support the deployment of all panels 32, 33, 34, 35, 36. After using the apparatus 10 during the course of the construction project, it is folded back and fully collapsed by returning any used tools to the interior space 40 by lowering the panels 32, 33, 34, 35, 36. Whereby, the user may engage the lock 39 on the apparatus 10, and again transport it to a new desired stored location. Thus, the present apparatus 10 benefits the user by providing for the complete storage, transportation, and utilization solution for various power tools used during construction projects, and in particular finish carpentry work.

The apparatus 10 is designed to be of a size to allow a user to roll it without relying on a motor to move it, such as that illustrated in FIG. 9. This is designed to fit in the back of a typical user's truck, like a Ford 150®. The one embodiment that includes a motorized track could also leave off the track and just provide wheels. The directing of the motorized apparatus 10 can be done by hand held radio frequency remote control 95 or by any known other directional control device.

The best mode for carrying out the invention is presented in terms of its preferred embodiment, herein depicted within the illustrated figures. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the illustrated invention describes certain electric mounted tools, any known or yet to be developed tools that need to be used by a construction worker, and in particular as finishing carpentry tooling. For example, shop vacuums, band saws, drill presses, crimping and bending tooling, band saws, band sanders, etc.

Additionally, although the figures illustrate a certain location for each tool and panel, one skilled in the art will understand that these are completely interchangeable. For example, the panel 33 and 37 may be positioned at the other end, and the miter saw 63 could also be located at the other end of the assembly 10. Additionally, the location of the motor 88 may be located in any position sufficient to drive the belt 90.

It is also envisioned that any number of legs may be positioned around the work surface 100 as is needed to maintain the integrity of the levelness of the surface thereof.

Finally, it is envisioned that the components of the device may be constructed of a variety of materials. For example, the material could be metal, wood, plastic and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is desired to be claimed under Letters Patent is:

1. An integrated work surface and tool storage system, comprising:
a) a plurality of panels, forming a box shape, including:
i) a top panel having a miter saw coupled to one side thereof, wherein the top panel is in a closed position with the miter saw positioned inside and at one end of the box;
ii) a first side panel having a router coupled to one side thereof, wherein the side panel is in a closed position with the router positioned inside and in a middle portion of the box and next to the miter saw; and
iii) a second side panel, opposite the first side panel, having a circular saw coupled to one side of the second side panel, wherein the side panel is in a closed position with the circular saw positioned inside and at a second end of the box and next to the router;
b) a support structure, supporting at least the edges of the box shape formed by the plurality of panels; and
c) a plurality of hinges coupled to the support structure, that enable the plurality of panels to have a storable position state that fold the panels into a box shape, and a deployable panel state where the panels form a flat work surface located above the support structure;
wherein when the top panel is rotated to an open position, the miter saw is positioned on top of the working surface;
wherein when the first side panel is rotated to an open position, the router is positioned below the working surface with a router bit sticking through the first side panel and located above the working surface; and
wherein when the second side panel is rotated to an open position, the circular saw is positioned below the working surface with a circular saw blade sticking through the second side panel and extending above the working surface.

2. The integrated work surface and tool storage system of claim 1, further comprising a motorized system, coupled to the support structure, to be activated to cause the tool box to move.

3. The integrated work surface and tool storage system of claim 2, further comprising at least two wheels located on either side of the tool box, wherein at least one wheel is coupled to the motorized system.

4. The integrated work surface and tool storage system of claim 2, further comprising a first and second flexible continuous track coupled around each of the two wheels located on either side of the tool box.

5. The integrated work surface and tool storage system of claim 4, further comprising a radio frequency remote control device, electrically coupled, via radio frequency, to the motorized system, designed to enable a user to remotely control the movement of the tool box.

6. An integrated motorized work surface and tool storage system, comprising:
a) a toolbox, having:
i) a top panel having a first power tool coupled to one side thereof, wherein the top panel is in a closed position with the first power tool positioned inside and at one end of the box;
ii) a first side panel having a second power tool coupled to one side thereof, wherein the side panel is in a closed position with the second power tool positioned inside and in a middle portion of the box and next to the first power tool; and
iii) a second side panel, opposite the first side panel, having a third power tool coupled to one side of the second side panel, wherein the side panel is in a closed position with the third power tool positioned inside and at a second end of the box and next to the second power tool;
b) a motorized system, coupled to the tool box to be activated to cause the toolbox to move;
c) at least two wheels located on either side of the tool box, wherein at least one wheel is coupled to the motorized system; and
d) a radio frequency remote control device, electrically coupled to the motorized system, designed to enable a user to remotely control the movement of the tool box
wherein when the top panel is rotated to an open position, the first power tool is positioned on top of the working surface;
wherein when the first side panel is rotated to an open position, the second power tool is positioned below the working surface with a working portion sticking through the first side panel and located above the working surface; and
wherein when the second side panel is rotated to an open position, the third power tool is positioned below the working surface with a working portion sticking through the second side panel and extending above the working surface.

7. The integrated motorized work surface and tool storage system of claim 6, further comprising a first and second flexible continuous track coupled around each of the two wheels located on either side of the tool box.

8. The integrated motorized work surface and tool storage system of claim 7, further comprising:
a support structure; and
a plurality of panels, hingedly coupled to the support structure, that have a storable state that fold onto support structure, and a deployable state where the panels form a flat work surface located above the support structure.
